(19) United States
(12) Patent Application Publication
(10) Pub. No.: US 2017/0341659 A1
(43) Pub. Date: Nov. 30, 2017

(54) METHOD FOR PREDICTING THE SPEED OF A DRIVER DRIVING A VEHICLE

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: MARC DUVERNIER, Clermont-Ferrand (FR); BENOÎT GANDAR, Clermont-Ferrand (FR); CLÉMENT PETIT, Clermont-Ferrand (FR); DENIS MARTIN, Clermont-Ferrand (FR)

(21) Appl. No.: 15/534,786

(22) PCT Filed: Dec. 16, 2015
(86) PCT No.: PCT/EP2015/080070

§ 371 Date: Jun. 9, 2017

(30) Foreign Application Priority Data
Dec. 16, 2014 (FR) 1462495

(51) Int. Cl. B60W 40/09; B60W 30/14; B60W 50/14

(52) U.S. Cl. CPC B60W 40/09; B60W 50/14; B60W 30/143; B60W 2050/146; B60W 2520/10; B60W 2050/143

(57) ABSTRACT

The invention relates to a method for predicting the speed of a driver driving a vehicle, comprising the following steps:
the speed of the driver is measured in a first driving area,
this measured speed is compared with a set of speed profiles, each profile corresponding to a predetermined category of driver,
on the basis of the result of this comparison, the relevant category for the vehicle driver is selected, and
the speed of the driver in a second driving area is predicted on the basis of the reference profile of the selected category.

The invention also relates to a method for determining speed profiles for a prediction method according to the invention.

### TECHNICAL FIELD

The present invention relates to the prediction of the speed of a driver driving a vehicle in a driving area. This invention is applicable, notably, to the field of motor vehicles.

At the present time, motor vehicles are fitted with numerous devices for improving the safety of the driver and passengers of a vehicle. Thus, there are known braking systems (ABS) for preventing the locking of the wheels if strong braking occurs. There are also known electronic path correctors (ESP) which enable the skidding of vehicles to be avoided by controlling the path.

The development of these systems has been made possible by the installation of numerous electronic devices in vehicles, and the use of increasingly powerful electronic computers, enabling large amounts of computing power to be embedded in motor vehicles without taking up more space.

It is also known that excessively high, or inappropriate, vehicle speeds are among the most frequent causes of road accidents. Speed control or speed limiting systems enable a driver to set a maximum speed that must not be exceeded. However, these systems are not adaptive, and, although they can prevent excessively fast driving, they cannot ensure that the driver will travel at a suitable speed, for example in specific driving areas or situations, such as areas including corners. Furthermore, the speed controllers or limiters are controlled by the driver, who sets a maximum speed himself, without necessarily being aware of his driving profile relative to a route to be covered.

There is also a known method, disclosed in the American patent U.S. Pat. No.. 8,478,499, for predicting a vehicle speed on the basis of a speed history. However, it has been found that this method sometimes provides a prediction which is rather inappropriate for the driver of the vehicle.

The present invention is intended to overcome these drawbacks by providing a speed prediction method which is adapted to both the vehicle driver and a driving area in which the vehicle is to travel. The present invention also provides a method for the preliminary determination of the driver categories and reference profiles associated with these categories.

### BRIEF DESCRIPTION OF THE INVENTION

Thus the invention relates to a method for predicting the speed of a driver driving a vehicle relative to the road, comprising the following steps:
the speed of the driver is measured in a first driving area,
this measured speed is compared with a set of speed profiles, each profile corresponding to a predetermined category of driver,
on the basis of the result of this comparison, the relevant category for the vehicle driver is selected, and
the speed of the driver in a second driving area is predicted on the basis of the reference profile of the selected category.

Mention is made here of the speed “of a driver”, since the invention relates to a prediction method which is dependent on a person driving a vehicle. However, the speed considered here is actually the speed of the vehicle driven by a driver, relative to the road. This interpretation is valid for all mentions of speed in this text. The same applies to “acceleration” when this term is used.

The method for the preliminary definition of a certain number of driver categories is detailed below.

In the rest of the description, the terms “classify” and “categorize” will be used in an equivalent manner Similarly, the terms “category” and “profile” will also be used in an equivalent manner in some cases, since each driver category corresponds to a single reference profile.

In a preferred embodiment, the invention relates to a prediction method further comprising the following steps:
a distance from the driver's profile to the reference profile of the selected category is determined, and
the predicted speed is corrected on the basis of this distance.

In a preferred embodiment, the prediction method is such that the driver's acceleration in the first driving area is measured, in addition to the driver's speed, and this measurement of acceleration is used to select the relevant category of driver.

In a preferred embodiment, the step of predicting the speed consists in assigning to the driver the mean speed of the selected category in the second driving area, or in a driving area having similarities with the driving area approached by the vehicle.

In a preferred embodiment, the prediction method further comprises the step of correcting the predicted speed on the basis of external parameters. These parameters are, for example, included in the group comprising: meteorological parameters, parameters concerning the state of the road, parameters concerning the motor traffic and parameters concerning the vehicle.

In a preferred embodiment, the prediction method comprises a step of transmitting the predicted speed to a driver assistance device installed in the vehicle. The expression “driver assistance system” is taken to mean, for example, a device of the “adaptive cruise control” type.

In another preferred embodiment, the prediction method comprises a step of transmitting the predicted speed to a display and/or warning device, which may be audible and/or visual, available to the driver of the vehicle.

The invention also relates to a method for determining speed profiles for a method for determining speed, in which the method comprises the following steps:
data representative of the driving speed of a predetermined group of drivers in a predefined driving area are acquired, each driver being considered as an individual,
a hierarchical classification of the individuals is performed to divide them into a number of classes defined on the basis of the data, and
a profile speed is determined for each class determined in this way.

In an advantageous embodiment, the hierarchical classification used is an ascending hierarchical classification (AHC).

It should be noted here that the steps for categorizing the individuals in a predetermined number of categories may be used independently of the present invention. This is because it would be feasible to use the categorization of individuals in order to market services on the basis of an individual's profile, for example.

In a preferred embodiment, the hierarchical classification is performed by using only a portion of the data, the data being selected from the observations made in the predetermined relevant driving areas.

### DETAILED DESCRIPTION OF THE INVENTION

### Determination of the Driver Categories

As described above, in order to determine the driver categories, the speed of a certain number of individuals over the same route is observed, and a hierarchical classification is performed on all the available observations. It should be noted here that the variables are recorded at a frequency appropriate to the recording means. In statistical terms, these variables are considered to be a set of point observations, rather than continuous curves. Thus a set of observations is associated with each individual for each of these passages.

The principle of this classification is that of using a suitable concept of distance to group the users into classes, each class being as homogeneous as possible, and as distinct as possible from the other classes. In an exemplary embodiment, the classes are such that the intra-class variance is minimized, while the inter-group variance is maximized.

Advantageously, in order to perform the classification, the speed of an individual is recorded over a plurality of passages along the same route, each passage resulting in a set of observations. To define the distance between two users, the distance between the reference speeds of each of these users is calculated.

When the classes are determined, the mean speed of each class, also called the profile speed, is determined.

In this kind of hierarchical classification, the number of classes used is selected a posteriori, and is considered suitable if the inter-class variance does not decrease significantly when a class is added.

Thus, in an exemplary embodiment of the present invention, the use of six classes is proposed, to minimize the inter-class variance. However, it has been found that equally relevant results can be obtained with four classes. Consequently, this number of four classes is preferably selected for reasons of parsimony. This makes it possible to reduce the computing power and time required.

Also in the interests of parsimony, in an exemplary embodiment, the categories are determined by using only some of the available observations, instead of all of these observations. For example, observations in relevant driving areas, such as corners or areas of high acceleration, will be selected.

The relevant driving areas are determined, for example, on the basis of a map of the driving area, or on the basis of vehicle behaviour when passing through these areas, the behaviour being, for example, analysed in terms of the vehicle speed and/or acceleration in these areas.

### Reference Speed of an Individual

The reference speed used for the classification may be selected in different ways. Thus, in one example, the reference speed is the median of the various speeds of passage of a user.

In another example, an artificial reference called the “speed at 75%” is selected. This speed is determined by taking the third quartile of the speed of a user in each of these passages at each observation.

### Classification of an Individual in a Category

To classify a new individual, not yet considered, in one of the categories determined as mentioned above, the distance between the reference speed of this new individual and the profile speed of each class is determined. The individual is then classified in the class for which this distance is smallest.

To ensure that this classification is performed in a relevant manner, it is helpful if the compared speeds have been determined in similar driving areas, or in areas having characteristics in common

Thus, in one example, the reference speed of the individual is determined over a route declared in advance by the individual. In order to discover the characteristics of this route, the method may be enriched, for example, by using cartographic data.

In another example, the reference speed of the individual is determined in a set of predefined characteristic areas. A characteristic area is, for example, a corner having a certain radius of curvature, an area of rapid acceleration, or a steep slope.

### Predicting the Speed of an Individual

When the individual has been classified in a certain category, his speed in a future driving area may be predicted, using the speed profile of this category.

For this purpose, the speed is predicted at each unit of time, by taking the categories into account and assigning the profile speed of the category to each driver.

The term “profile speed” is taken to mean a statistically determined speed belonging to the group comprising the mean speed of the individuals of a category, the median speed of the individuals of a category, a quantile of any order of the distribution of the speeds of the individuals of a category, or any other statistical estimator representative of the speeds of the set of individuals in a category.

In an advantageous embodiment, the step of predicting the driver's speed in a second driving area consists in predicting the speed at a number of finite points of the second driving area and making an approximation between these points. Thus, for example, the speed is predicted only in certain specific areas, where the speed varies considerably, and an approximation is made between these areas. This embodiment makes it possible to reduce the computing power used for the prediction. It should be noted here that the selection of the points is performed on the basis of speed variations, and therefore does not necessarily exhibit a regular distribution over the driving area.

Advantageously, the speed predicted in this way is corrected on the basis of external parameters, such as:
the maximum legally authorized speed for the driving area,
meteorological data,
data concerning the roadway, for example information about a locally reduced level of grip.

In another exemplary embodiment, the predicted speed is corrected by using a statistically established sub-behaviour of the individual in characteristic areas such as corners.

In yet another example, the predicted speed is corrected by using the distance of the individual from the mean of his class. This is because, although the categorization of the individuals enables a relatively relevant prediction to be made, this prediction may be refined, notably for individuals at the extremes of each category.

### Execution of a Method According to the Invention

In an exemplary embodiment, a method according to the invention is executed in practice as follows:
The reference profiles are initially downloaded to a memory embedded in a vehicle,
When a driver sits at the wheel, the memory is checked to determine whether he has already been categorized in one of the existing profiles,
If the driver has not been categorized, the steps for assigning a category to him are executed,
The profile determined in this manner is stored in memory, and
The speed is predicted on the basis of this reference profile.

In one embodiment, the execution of the method may comprise a step of changing the category of an individual if the recordings made at the start of a route show an excessively wide dispersion relative to a category determined in advance.

In another embodiment, the driver's profile is not stored in a memory of the vehicle, but in a remote database. In this case, the vehicle retrieves the information from this database when an individual sits at the steering wheel, via telecommunication means installed in the vehicle.

1-11. (canceled)

12: A prediction method for predicting a speed of a driver driving a vehicle relative to a road, the method comprising steps of:
measuring a speed of the driver in a first driving area to obtain a measured speed;
comparing the measured speed with a set of speed profiles to obtain a comparison result, each of the speed profiles corresponding to a predetermined category of driver;
based on the comparison result, selecting a relevant category for the driver; and
predicting a speed of the driver in a second driving area based on a reference profile corresponding to the relevant category selected for the driver.

13: The prediction method according to claim 12, further comprising steps of:
determining a distance from a profile of the driver to the reference profile corresponding to the relevant category selected for the driver, and
correcting the speed predicted in the predicting step based on the distance determined in the determining step.

14: The prediction method according to claim 12, further comprising steps of:
measuring an acceleration of the driver relative to the road in the first driving area to obtain a measured acceleration, and
utilizing the measured acceleration in the selecting step to select the relevant category for the driver.

15: The prediction method according to claim 12, wherein the predicting step includes assigning a profile speed of the selected category for the driver in the second driving area.

16: The prediction method according to claim 12, wherein the predicting step includes predicting a speed at a number of finite points of the second driving area and making approximations between the points.

17: The prediction method according to claim 12, further comprising a step of correcting the speed predicted in the predicting step based on one or more external parameters.

18: The prediction method according to claim 17, wherein the external parameters include meteorological parameters, parameters concerning a state of the road, parameters concerning motor traffic, and parameters concerning the vehicle.

19: The prediction method according to claim 12, further comprising a step of transmitting the speed predicted in the predicting step to a driver assistance device installed in the vehicle.

20: The prediction method according to claim 12, further comprising a step of transmitting the speed predicted in the predicting step to at least one of: a display and a warning device on the vehicle and available to the driver.

21: A method for determining speed profiles used to predict a driver speed of a driver driving a vehicle relative to a road, in which each of the speed profiles corresponds to a predetermined category of driver and in which the driver speed is predicted by measuring a speed of the driver in a first driving area to obtain a measured speed, comparing the measured speed with a set of the speed profiles to obtain a comparison result, selecting a relevant category for the driver based on the comparison result, and predicting the driver speed in a second driving area based on a reference profile corresponding to the category selected for the driver, the method comprising steps of:
acquiring data representative of a driving speed of a group of drivers in a predefined driving area, each of the drivers being considered as an individual;
classifying the individuals hierarchically by dividing the drivers into a number of classes defined based on the data; and
determining a profile speed for each of the classes.

22: The method for determining speed profiles according to claim 21, wherein the classifying step is performed by using a portion of the data selected from observations made in predetermined relevant driving areas.
